(19) United States
(12) Patent Application Publication
(10) Pub. No.: US 2023/0284551 A1
(43) Pub. Date: Sep. 14, 2023

(54) CULTIVATOR

(71) Applicant: Brandt Industries Canada Ltd., Regina (CA)

(72) Inventors: Blake Neudorf, Warman (CA); Dale Summach, Saskatoon (CA); Brian Rudin, Bloomington, IL (US); Alex Hansen, Saskatoon (CA); Greg Swanson, Vanscoy (CA)

(21) Appl. No.: 17/940,146

(22) Filed: Sep. 8, 2022

(30) Foreign Application Priority Data
Mar. 14, 2022 (CA) 3152333

(51) Int. Cl. A01B 73/06; A01B 63/22; A01B 63/32

(52) U.S. Cl. CPC A01B 73/065; A01B 63/22; A01B 63/32

(57) ABSTRACT

A cultivator is provided. The cultivator can have a main frame having a front end and a back end, a hitch assembly connected to the front end of the main frame, a tilling section attached to the back end of the main frame, a pair of main ground wheels, a first wing ground wheel and a second wing ground wheel, a plurality of ground engaging tools connected to and extending below the tilling section.

The present invention relates to a cultivator and, more particularly, a high-speed cultivator for cultivating or tilling a field.

### BACKGROUND

Cultivators are used in agriculture to till a field by mechanically agitating the soil. This can be done for a number of reasons including to prepare a good seedbed for crops to be planted in the field. With the increasing size of many agricultural operations and the increase in the area of the fields being seeded and harvested, modern cultivators have increased in size in order to cover more of a field with each pass and have been designed to operate at higher speeds to they can till a field faster. However, while the size and speed of operation of these more modern cultivators have allowed operators to till a field faster than more traditional cultivators, this increase in size and speed have created additional complications for these cultivators.

### SUMMARY OF THE INVENTION

In a first aspect, a cultivator is having a main frame having a front end and a back end, a hitch assembly connected to the front end of the main frame, a tilling section pivotally attached to the back end of the main frame to pivot around a pivot axis, a pair of main ground wheels attached to the main frame, the main ground wheels defining a ground wheel axis passing through centers of the main ground wheels, a first wing ground wheel and a second wing ground wheel attached to a front end of the tilling section, and a plurality of ground engaging tools connected to and extending below the tilling section. The ground wheel axis is substantially aligned with the pivot axis in a horizontal direction.

In a further aspect, a cultivator is provided having a main frame having a front end and a back end, a hitch assembly connected to the front end of the main frame, a tilling section having a front end and a back end, the tilling section pivotally attached to the back end of the main frame to pivot around a pivot axis, a pair of main ground wheels vertically moveable relative to the front end of the tilling section, ground wheel actuators connected to the main ground wheels to vertically raise and lower the main grounds wheels relative to the front end of the tilling section, a first wing ground wheel and a second ground wheel vertically moveably relative to the front end of the tilling section, a first wing ground wheel actuator connected to the first wing ground wheel to move the first wing ground wheel vertically, a second wing ground wheel actuator connected to the second wing ground wheel to move the second wing ground wheel vertically, a plurality of ground engaging tools connected to and extending below the tilling section, a plurality of packer assemblies pivotally connected to the back end of the tilling section, each packer assembly having a packer roller, the packer roller vertically moveable relative to a back end of the tilling section, a packer actuator connected between the tilling section and each packer assembly to raise and lower the packer roller. A front hydraulic circuit operably connected to the main ground wheel actuators to extend and retract the main ground wheel actuators and a back hydraulic circuit operably connected to the packer actuators to extend and retract the packer actuators. The front hydraulic circuit and the back hydraulic circuit are operably connected in parallel. The plurality of ground engaging tools can include a first row of ground engaging tools and a second row of ground engaging tools. The first row of ground engaging tools positioned in front of and parallel to the second row of ground engaging tools.

In a further aspect, a cultivator is provided having a hitch assembly connectable to a tow vehicle, a tilling section having a front end and a back end, a plurality of ground engaging tools connected to and extending below the tilling section, a packer assemblies pivotally connected to the back end of the tilling section and having a packer roller, the packer roller vertically moveable relative to a back end of the tilling section; a packer actuator connected to the packer assembly to raise and lower the packer roller, and a suspension element operably connected between the packer actuator and the tilling section, the element having a compression element to absorb a compression load.

### DESCRIPTION OF THE DRAWINGS

A preferred embodiment of the present invention is described below with reference to the accompanying drawings, in which:

FIG. 1 is a top view of a cultivator;

FIG. 2 is a side view of the cultivator shown in FIG. 1;

FIG. 3 is a perspective view of the cultivator shown in FIG. 1;

FIG. 4 is a rear perspective view of the cultivator shown in FIG. 1;

FIG. 5 is a close up view of cultivator along line A of FIG. 4;

FIG. 6 is a perspective view of the cultivator shown in FIG. 1 in a transport position;

FIG. 7 is schematic illustration of a cultivator with poor geometry affecting the depth the ground engaging tools penetrate a ground surface as a tow vehicle pulling the cultivator passes through a dip in a field;

FIG. 8 is a schematic illustration of the cultivator of FIG. 7 as the tow vehicle passes over a rise in a field;

FIG. 9 is a close up view of the cultivator of FIG. 1 showing the substantial alignment in the horizontal direction of the ground wheel axis and the pivoting axis;

FIG. 10 is schematic illustration of the cultivator shown in FIG. 1 as a tow vehicle pulling the cultivator through the field passes through a dip in a field;

FIG. 11 is a schematic illustration of the cultivator of FIG. 1 as a tow vehicle pulling the cultivator passes over a rise in a field;

FIG. 12 is a schematic illustration of a hydraulic circuit showing a hydraulic circuit for controlling the depth ground engaging tools of a cultivator engage soil;

FIG. 12A is a schematic illustration of a hydraulic circuit showing a hydraulic circuit using a sequence valve for controlling the depth ground engaging tools of a cultivator engage soil;

FIG. 13 is a schematic illustration of a tilling section from the side showing a suspension element; and

FIG. 14 is a perspective view of a suspension element.

### DETAILED DESCRIPTION OF THE ILLUSTRATED EMBODIMENTS

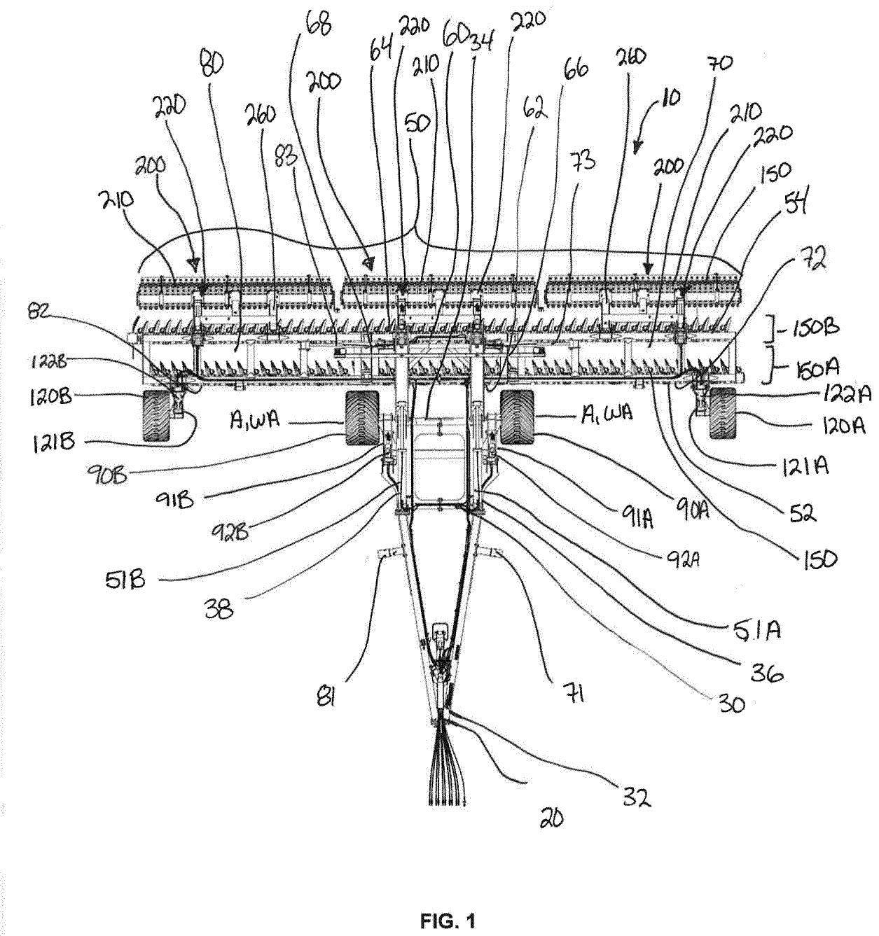

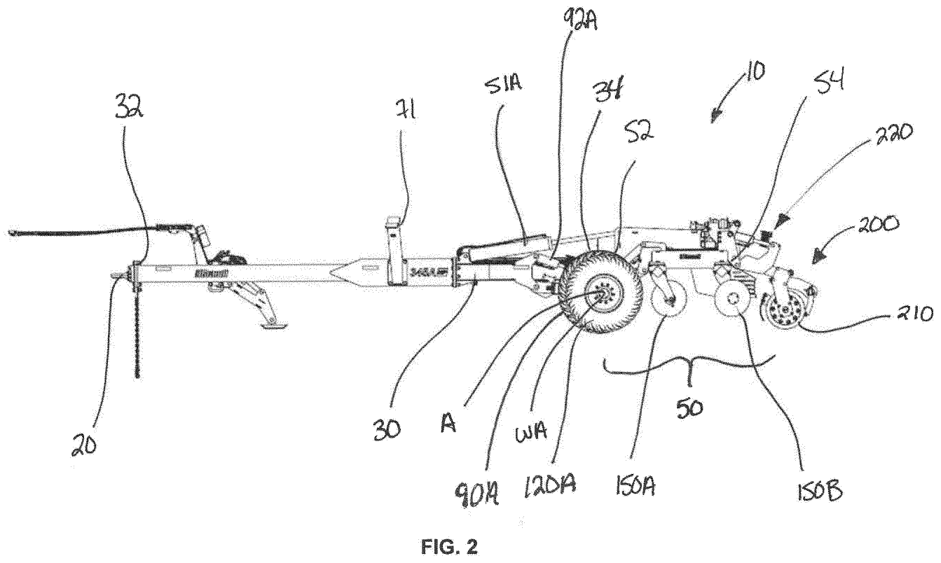

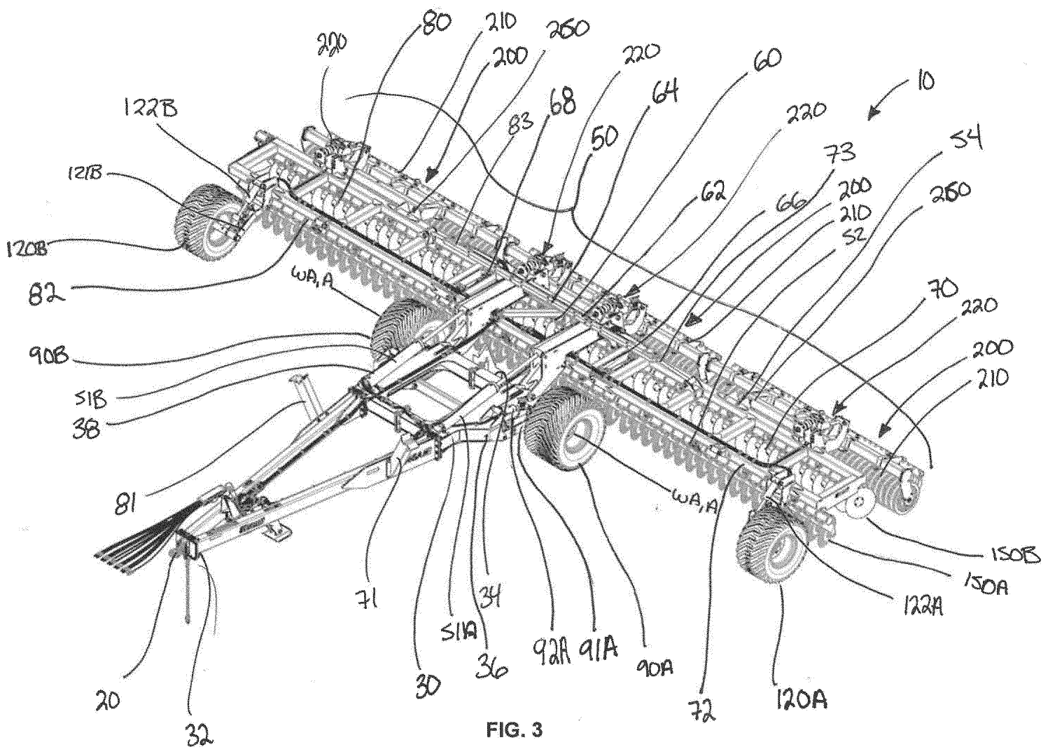

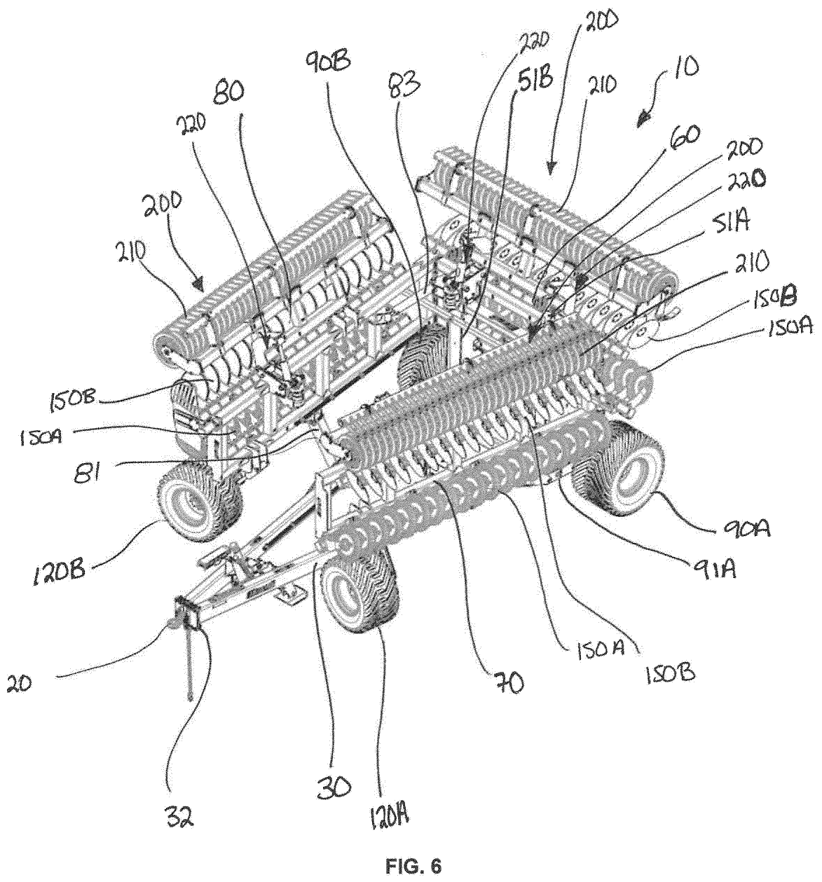

FIGS. 1-4 illustrate a cultivator 10 for cultivating or tilling a field, typically used for growing agricultural crops. The cultivator 10 is pulled behind a tow vehicle (not shown), while the cultivator 10 is in a field position (as shown in FIG. 1-4). Ground engaging tools 150 extend down from the cultivator 10 to penetrate into the soil of the field and till the soil in the field as the cultivator 10 is pulled through the field by the tow vehicle. The cultivator 10 can be transformed into a transport position, as shown in FIG. 6, so that it can be towed from field to field, such as along a public roadway. The cultivator 10 can comprise: a hitch assembly 20; a main frame 30; a tilling section 50 having a rear frame 60, a first wing frame 70, and a second wing frame 80; tilling section actuators 51A, 51B; a first wing actuator 73; a second wing actuator 83; a pair of main ground wheels 90A, 90B; ground wheel actuators 92A, 92B; a pair of wing ground wheels 120A, 120B; wing ground wheel actuators 122A, 122B; ground engaging tools 150; packing assemblies 200; bracket assemblies 220; and packer actuators 225.

The main frame 30 can have a front end 32 and a back end 34 with the hitch assembly 20 connected to the front end 32 of the main frame 30 for attachment to the tow vehicle (not shown). The main frame 30 can be pivotally attached to the tilling section 50, comprising the rear frame 60, the first wing frame 70, and the second wing frame 80, by the back end 34 of the main frame 30 being pivotally connected to the rear frame 60 so that the rear frame 60 can pivot upwards around a pivot axis A at the back end 34 of the main frame 30.

The pair of main ground wheels 90A, 90B can be attached to the main frame 30 with a first main ground wheel 90A attached to a first side 36 of the main frame 30 and a second main ground wheel 90B attached to a second side 38 of the main frame 30. The main ground wheels 90A, 90B are movably attached to the main frame 30 by swing arms 91A, 91B so that the main ground wheels 90A, 90B can be moved vertically, through an arc defined by the swing arms 91A, 91B, relative to the main frame 30 to raise and lower the main frame 30 relative to the main ground wheels 90A, 90B and thereby alter the height of the main frame 30 above the ground surface. The main ground wheels 90A, 90B can define a ground wheel axis WA passing through the center of the main ground wheels 90A, 90B and which the main ground wheels 90A, 90B rotate around.

The ground wheel actuators 92A, 92B, which can be double acting hydraulic cylinders, can be connected to the main ground wheels 90A, 90B to raise and lower the main ground wheels 90A, 90B. In one aspect, the ground wheel actuators 92A, 92B can extend between the main frame 30 and the swing arms 91A, 91B the main ground wheels 90A, 90B are connected to in order to move the main ground wheels 90A, 90B vertically, through an arc defined by the swing arms 91A, 91B, relative to the main frame 30.

A pair of tilling section actuators 51A, 51B, such as double acting hydraulic cylinders, can be provided extending between the main frame 30 and the rear frame 60. Retracting these tilling section actuators 51A, 51B will cause the rear frame 60 to pivot upwards relative to the main frame 30 and around pivot axis A at the back end 34 of the main frame 30. Extending these tilling section actuators 51A, 51B will pivot the rear frame 60 downwards relative to the main frame 30 and around the pivot axis A at the back end 34 of the main frame 30.

The rear frame 60, the first wing frame 70, and the second wing frame 80 together form the tilling section 50 having a front end 52 and a back end 54.

The rear frame 60 will have a front end 62, a back end 64, a first side 66, and a second side 68. The front end 62 of the rear frame 60 can be pivotally connected to the back end 34 of the main frame 30 to pivot around the pivot axis A. The first side 66 of the rear frame 60 can be pivotally connected to the first wing frame 70 and the second side 68 of the rear frame 60 can be pivotally connected to the second wing frame 80.

The first wing frame 70 can be pivotally connected to the first side 66 of the rear frame 60 so that the first wing frame 70 can pivot relative to the rear frame 30 around the first side 66 of the rear frame 60. The first wing ground wheel 120A can be attached at a front end 72 of the first wing frame 70 and movably attached to the front end 72 first wing frame 70 by a swing arm 121A so that the first wing ground wheel 120A can be moved vertically, through an arc defined by the swing arm 121A, relative to the front end 72 of the first wing frame 70 to raise and lower the front end 72 of the first wing frame 70 and adjust the height of the front end 72 of the first wing frame 70 above ground surface.

The first wing ground wheel actuator 122A, which can be a double acting hydraulic cylinder, can be used to vary the height between the first wing ground wheel 120A and the front end 72 of the first wing frame 70. The first wing ground wheel actuator 122A can be connected between the first wing frame 70 and the swing arm 121A the first wing ground wheel 120A is connected to in order to move the first wing ground wheel 120A vertically, through the arc defined by the swing arms 121A, relative to the front end 72 of the first wing frame 70.

An first wing actuator 73, which can be a double acting hydraulic cylinder, can be connected between the rear frame 60 and the first side frame 70 so that the first wing actuator 73 can pivot the first wing frame 70 around the first side 66 of the rear frame 60 by retracting and extending the first wing actuator 73.

The second wing frame 80 can be pivotally connected to the second side 68 of the rear frame 60 so that the second wing frame 80 can pivot relative to the rear frame 60 around the second side 68 of the rear frame 60. The second wing ground wheel 120B can be attached at a front end 82 of the second wing frame 80 and movably attached to the front end 82 of the second wing frame 80 by a swing arm 121B so that the second wing ground wheel 120B can be moved vertically, through an arc defined by the swing arm 121B, relative to the front end 82 of the second wing frame 80 to raise and lower the front end 82 of the second wing frame 82 and adjust the height of the front end 82 of the second wing frame 80 above the ground surface.

The second wing ground wheel actuator 122B, which can be a double acting hydraulic cylinder, can be used to vary the height between the second wing ground wheel 120B and the front end 82 of the second side frame 80. The second wing ground wheel actuator 122B can be connected between the second wing frame 80 and the swing arm 121B the second wing ground wheel 120B is connected to in order to move the second wing ground wheel 120B vertically, through the arc defined by the swing arm 121B, relative to the front end 82 of the second wing frame 80.

Attached below the tilling section 50 and, specifically, the rear frame 60, the first wing frame 70 and the second wing frame 80, are the ground engaging tools 150 extending downwards beneath the tilling section 50 for penetrating the ground surface and engaging with the soil. The ground engaging tools 150 can positioned in a first row of ground engaging tools 150A and a second row of ground engaging tools 150B in the tilling section 50. The first row of ground engaging tools 150A can be positioned in front of, and parallel to, the second row of ground engaging tools 150B.

Ground engaging tools 150 can be discs, coulter discs, harrow tines, ploughs, shanks, etc.

Packer assemblies 200 can be attached to the back end 54 of the tilling section 50 to pack and flatten the soil after it has been tilled up by the ground engaging tools 150 in the tilling section 50 with one packer assembly 200 attached behind the rear frame 60, one packer assembly 200 attached behind the first wing frame 70 and one packer assembly 200 attached behind the second wing frame 80.

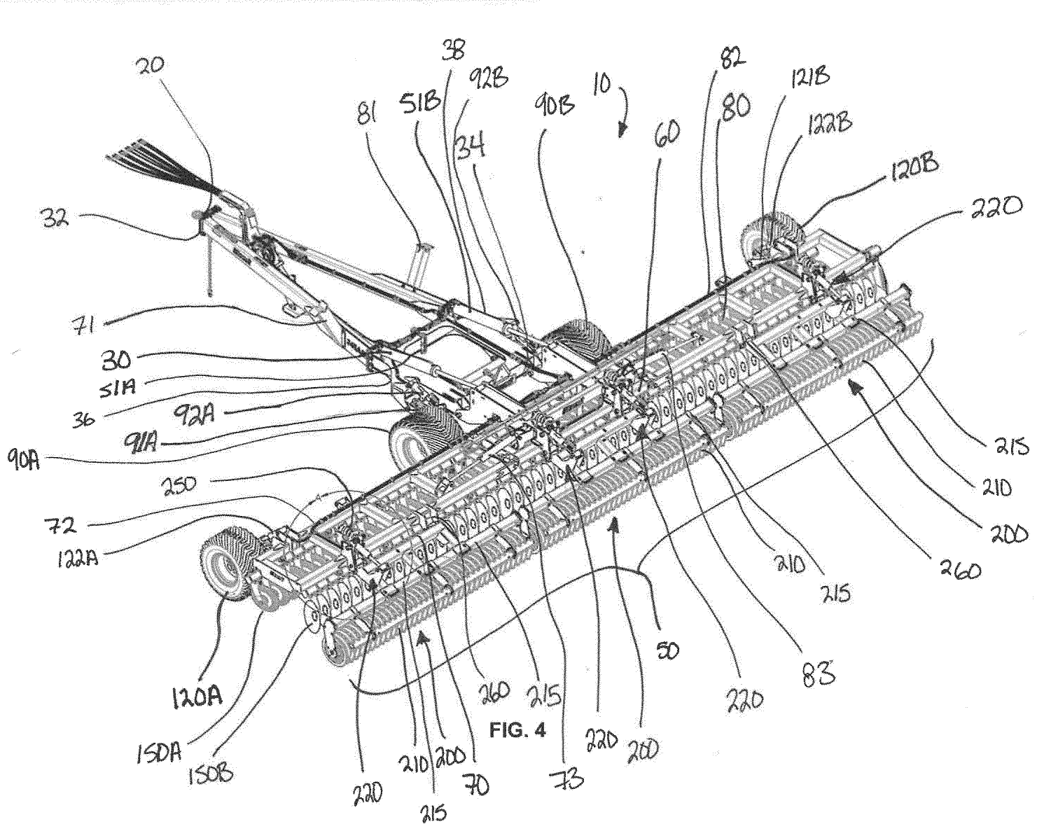

Referring to FIG. 4, each packing assembly 200 can have a packer roller 210 pivotally connected to a packer frame 215, which packer frame 215 can be pivotally connected to the back end 54 of the tilling section 50 by one or more bracket assemblies 220. The packer frame 215 connected to the first wing frame 70 and the packer frame 215 connected to the second wing frame 80 can also be pivotally connected by connection brackets 260 that freely pivot.

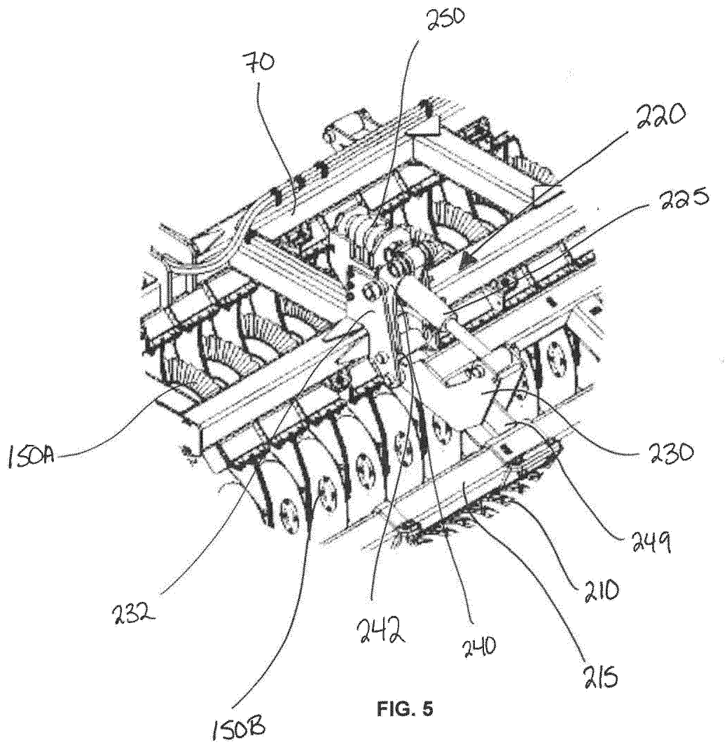

The bracket assemblies 220 allow the packer assemblies 200 to be selectively pivoted around the back end 54 of the tilling section 50. Referring to FIG. 5, the bracket assembly 220 can include: a packer actuator 225, a packer bracket 230; a frame bracket 232; an intermediate link 240; a suspension element 250; and a roller linkage 249 for connection to packer frame 215.

The roller linkage 249 can be connected to the packer frame 215 on one end and pivotally connected to the rear end 54 of the tilling section 50 at a second end. The packer bracket 230 can be connected, extending upwards, from the roller linkage 249. The frame bracket 232 can be connected to one of the frames in the tilling section 50 and expending upwards. The intermediate link 240 can be pivotally connected to the frame bracket 232 at a first end 242 of the intermediate link 240 so that the intermediate link 240 can pivot around the first end 242 of the intermediate link 240 relative to the frame bracket 232.

The packer actuator 225, which can be a double acting hydraulic cylinder, can be connected between the packer bracket 230 and the intermediate link 240, a first distance from the first end 242 of the intermediate link 240.

The suspension element 250 can be connected between the frame bracket 232 and the intermediate link 240, a second distance from the first end 242 of the intermediate link 240.

The bracket assembly 220 can cause the packer assembly 200 to be selectively pivoted around the back end 54 of the tilling section 50 using the packer actuator 225 and thereby raise and lower the height of the packer roller 210 relative to the back end 54 of the tilling section 50. By extending the packing actuator 225, the packer bracket 230 and thereby the packer frame 215 and the packer roller 210, can be pivoted downwards relative to the back end 54 of the tilling section 50, thereby lowering the packer roller 210 and raising the back end 54 of the tilling section 50 relative to the ground surface. By retracting the packing actuator 225, the packer bracket 230 and thereby the packer frame 215 and the packer roller 210, can be pivoted upwards relative to the back end 54 of the tilling section 50, thereby raising the packer roller 210 and lowering the back end 54 of the tilling section 50 relative to the ground surface.

The cultivator 10 can be transformed from the field position, as shown in FIGS. 1-4, to the transport position, shown in FIG. 6 for transport from field to field. The tilling section actuators 51A, 51B can be retracted to pivot the tilling section 50 upwards and specifically the rear frame 60 around pivot axis A relative to the main frame 30. This will lift the rear frame 60 as well as the first wing frame 70 and the second wing frame 80 that are attached to the sides 66, 68 of the rear frame 60, up off the ground surface. The main ground wheels 90A, 90B are attached to the main frame 30 so the main ground wheels 90A, 90B will remain in place as the tilling section 50 is pivoted upwards around the back end 34 of the main frame 30. As the tilling section 50 is pivoted upwards to perpendicular relative to the main frame 30, the weight of the tilling section 50 will move forward onto the main ground wheels 90A, 90B attached to the main frame 30.

When the tilling section 50 is pivoted to substantially perpendicular relative to the main frame 30, the first wing actuator 73 can be use to pivot the first wing frame 70 relative to the rear frame 30, forwards towards the front end 32 of the main frame 30 and the second wing actuator 83 can be used to pivot the second wing frame 80 relative to the rear frame 30, forwards towards the front end 32 of the main frame 30. The first wing frame 70 can be rested on, and connected to, a first wing brace 71 and the second side wing frame 80 can be rested on, and connected to, a second wing brace 81 to secure the first and second wing frames 70, 80 in the transport position shown in FIG. 6.

When the cultivator 10 is being towed in the transport position, the weight that is carried on the main ground wheels 90A, 90B and the tow vehicle is much easier to predict because there is no fore and aft motion. However, while having its advantages for towing the cultivator 10 in the transport position, mounting of the main ground wheels 90A, 90B to the main frame 30 instead of the rear frame 60 (like the wing ground wheels 120A, 120B are mounted to the wing frames 70, 80), can cause problems when the cultivator 10 is in the field position and being pulled through a field to till the soil. The positioning of the main ground wheels 90A, 90B on the main frame 30 can affect the depth control of the soil engaging tools 150 on the tilling section 50 if the geometry of the main frame 30 and the main ground wheels 90A, 90B is not set up a specific way.

If the ground wheel axis WA is positioned a horizontal distance in front of the pivot axis A, the ground wheel axis WA can act as a fulcrum and amplify the movement of the main frame 30 affecting the depth the ground engaging tools 150 penetrate the ground surface.

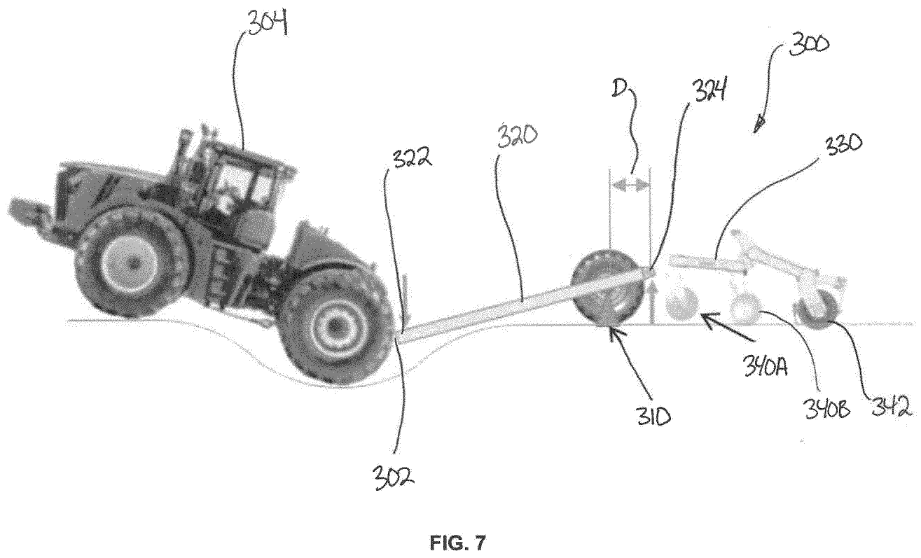

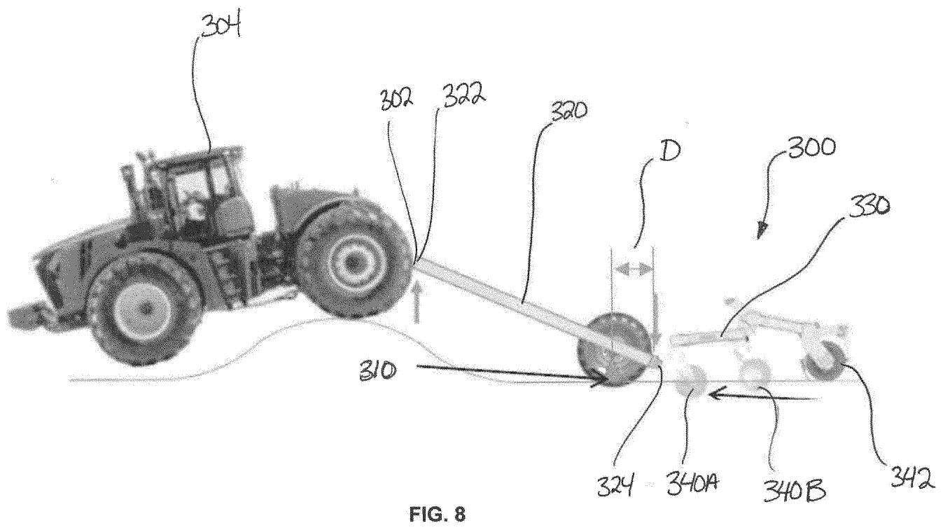

Referring to FIGS. 7 and 8, a prior art cultivator 300 with poor geometry is shown. For cultivator 300, the ground wheels 310 are connected to a main frame 320 a distance D from a back end 324 of the main frame 320. A tilling section 330 is pivotally connected to the back end 324 of the main frame 320 and has a first row of ground engaging tools 340A and a second row of ground engaging tools 340B positioned behind the first row of ground engaging tools 340A. A packer roller 342 is connected behind the tilling section 330.

When a hitch assembly 302, connecting the cultivator 300 to a tow vehicle 304, is moved downwards, such as when the tow vehicle 304 passes through a dip in the field, as shown in FIG. 7, the main frame 320 will move downwards at its front end 322 with the ground wheels 310 acting as fulcrum and the rear end 324 of the main frame 320 moving upwards relative to the ground surface. The front end of the tilling section 330, that is pivotally attached to the rear end 324 of the main frame 320, will also be moved upwards, with the packer roller 342 staying on top of the ground surface, which will in turn raise the first row of soil engaging tools 340A upwards, reducing the depth this first row of soil engaging tools 340A penetrate the ground surface or even moving the first row of ground engaging tools 340 up and out of the soil. The second row of ground engaging tools 340B can also rise up, decreasing the depth of penetration of the second row of ground engaging tools 340B in the soil, but not to the same extent as the first row of ground engaging tools 340A.

When the hitch assembly 302 is moved upwards, such as when the tow vehicle 304 passes over a rise in the field, as shown in FIG. 8, the main frame 320 will move upwards at its front end 322 with the ground wheels 310 acting as fulcrum and the rear end 324 of the main frame 320 moving downwards relative to the ground surface. The front end of the tilling section 330, that is pivotally attached to the rear end 324 of the main frame 320, will also be moved downwards, with the packing roller 342 staying to top of the ground surface. This will lower the first row of soil engaging tools 340A downwards, increasing the depth this first row of soil engaging tools 340A penetrate the ground surface. The second row of ground engaging tools 340B can also be lowered, increasing the depth of penetration of the second row of ground engaging tools 340B as well, but not to the same extent as the first row of ground engaging tools 340A.

This geometry causing the ground wheels 310 on the main frame 320 to act as a fulcrum for the main frame 320 results in poor depth control of the ground engaging tools 340A, 340B as the tow vehicle 304 pulls the cultivator 300 through a field and through dips and rises in the field.

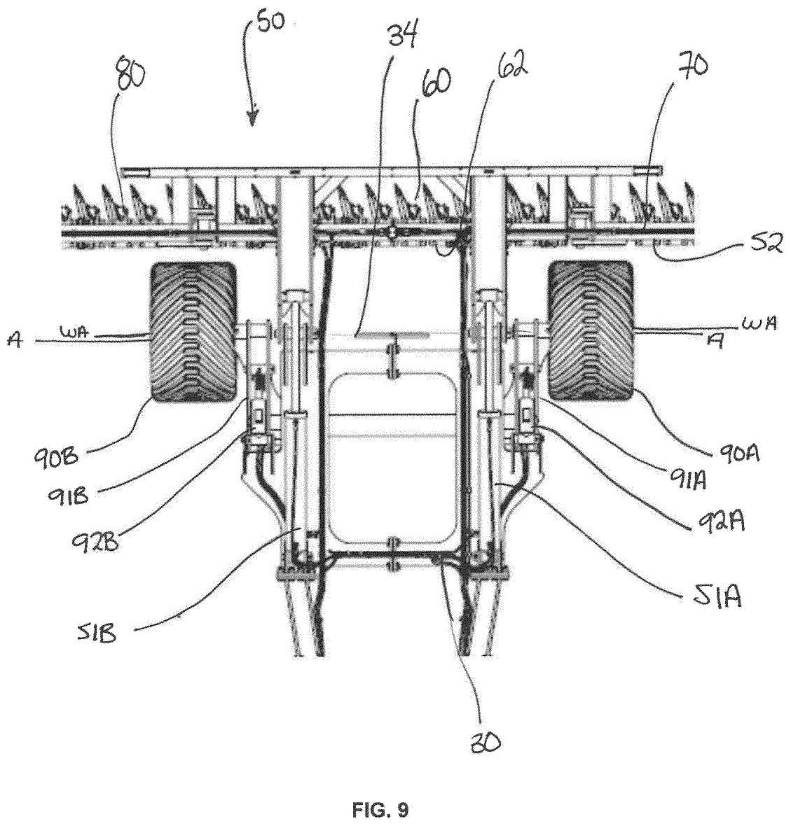

Referring again to FIG. 1, the ground wheel axis WA can be positioned proximate a back end 34 of the main frame 30 and the ground wheel axis WA and the pivot axis A can be substantially aligned in the horizontal direction. The ground wheel axis WA may be positioned substantially at or behind the back end 34 of the main frame 30. By placing the ground wheel axis WA proximate to the back end 34 of the main frame 30 and substantially aligning the ground wheel axis WA and the pivot axis A in the horizontal direction, the ground wheel axis WA does not act as a fulcrum for the main frame 30. FIG. 9 shows a close up view of the main ground wheels 90A, 90B and the pivotal connection between the rear frame 60 of the tilling section 50 and the main frame 30 around pivot axis A, showing the ground wheel axis WA positioned at a back end 34 of the main frame 30 and the ground wheel axis WA and the pivot axis A to be substantially aligned in the horizontal direction. The ground wheel axis WA and the pivot axis A being substantially aligned in the horizontal direction means the main ground wheels 90A, 90B will set the height of the front end 62 of the rear frame 60 and therefore the height of the front end 52 of the tilling section 50 relative to the ground surface and since the height of the main ground wheels 90A, 90B can be set to a fixed height relative to the main frame 30, the front end 52 of the tilling section 50 will also remain at a substantially fixed height relative to the ground surface, maintaining a more consistent depth of the first row of ground engaging tools 150A and the second row of ground engaging tools 150B.

The ground wheel axis WA and the pivot axis A may be at different vertical heights without affecting the height of the front end 52 of the tilling section 50. The ground wheel axis WA and the pivot axis A may also not be perfectly aligned in the horizontal direction, but rather substantially aligned in the horizontal direction. Because the main ground wheels 90A, 90B are connected to the main frame by swing arms 91A, 91B, respectively, the main ground wheels 90A, 90B will move vertically through an arc defined by the swing arms 91A, 91B. This will cause the main ground wheels 90A, 90B to move horizontally slightly, relative to the pivot axis A, as the ground wheels 90A, 90B are moved vertically through an arc defined by the swing arms 91A, 91B. This means the ground wheel axis WA and the pivot axis A may not be perfectly aligned at all times and heights of the main ground wheels 90A, 90B, but can be positioned proximate and close to each other or “substantially aligned”, rather than having a significant horizontal distance between them.

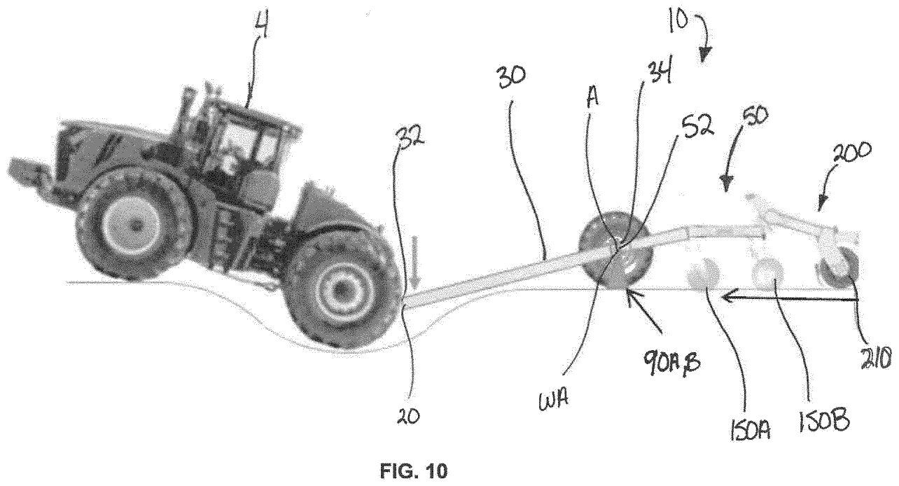

Referring to FIG. 10, unlike the cultivator 300 where the ground wheels 310 act as a fulcrum for the main frame 320, when a tow vehicle 4 pulling the cultivator 10 passes through a dip in the field, the hitch assembly 20 will move downwards and the main frame 30 will move downwards at its front end 32. However, the main ground wheels 90A, 90B, defining the ground wheel axis WA at the back end 34 of the main frame 30 and substantially aligned with the pivot axis A, which pivotally connects the back end 34 of the main frame 30 to the front end 52 of the tilling section 50, keep the front end 52 of the tilling section 50 at a substantially constant height relative to the ground surface, keeping the first row of ground engaging tools 150A and the second row of ground engaging tools 150B penetrating the ground surface at a substantially constant depth.

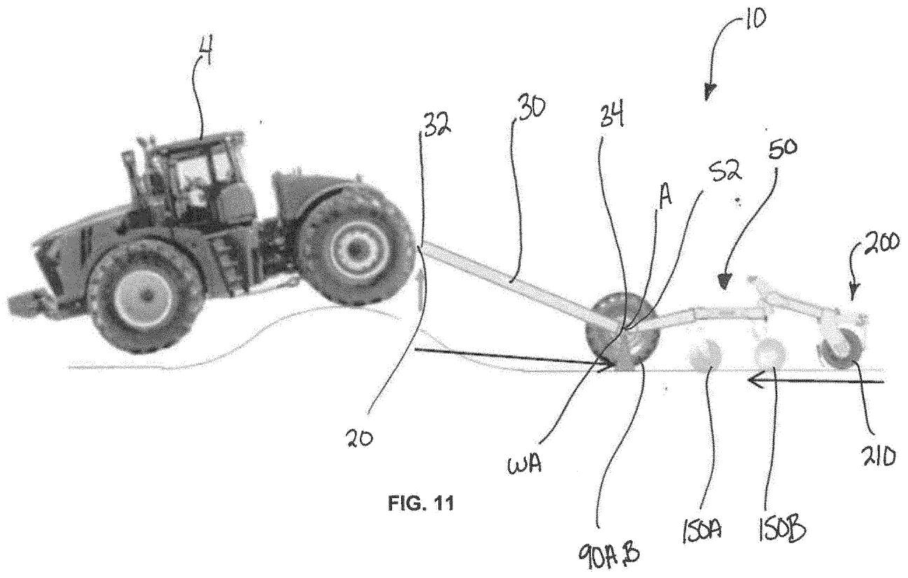

When the hitch assembly 20 of the cultivator 10, is moved upwards, such as when the tow vehicle 4 passes over a rise in the field, as shown in FIG. 11, the main frame 30 will move upwards at its front end 32. The main ground wheels 90A, 90B, defining the ground wheel axis WA at the back end 34 of the main frame 30 and substantially aligned horizontally with the pivot axis A, which pivotally connects the back end 34 of the main frame 30 to the tilling section 50, keeps the front end 52 of the tilling section 50 at a substantially constant height relative to the ground surface, keeping the first row of ground engaging tools 150A and the second row of ground engaging tools 150B penetrating the ground surface at a substantially constant depth.

Having the ground wheel axis WA proximate a back end 34 of the main frame 30 and substantially aligned in the horizontal direction with the pivot axis A, promotes consistent depth control with the ground engaging tools 150 in the tilling section 50 of the cultivator 10.

The cultivator 10 requires precise land contouring to engage the soil and maintain a substantially constant depth of penetration by the soil engaging tools 150. When the cultivator 10 is in the field position and being towed across a field to till the soil in the field, the tilling section actuators 51A, 51B can be put in a float position to allow the tilling section 50 to freely pivot relative to the main frame 30, around the pivot axis A. This allows the tilling section 50 to follow the ground surface contours; maintaining a substantially constant depth of penetration of the soil engaging tools 150 as the cultivator 10 is pulled over undulations in the field.

The first wing actuator 73 and the second wing actuator 83 can be pressurized to provide a downward force on the first wing frame 70 and the second wing frame 80, respectively, to compensate for the weight of the rear frame 60, which tends to be heavier than the first wing frame 70 or the second wing frame 80. By forcing the first wing frame 70 and the second wing frame 80 downwards, the weight the tilling section 50 places on the ground surface can be better equalized along the length of the tilling section 50.

In addition, the angle of the tilling section 50, and specifically the rear frame 60, the first wing frame 70 and the second wing frame 80 can be altered by changing the height of the front end 52 of the tilling section 50 and the height of the rear end 54 of the tilling section 50.

The ground wheel actuators 92A, 92B, which can vary the height of the main ground wheels 90A, 90B relative to the main frame 30, will also vary the height of the front end 62 of the rear frame 60 that is pivotally connected to the main frame 30. The first wing ground wheel actuator 122A can vary the height of the first wing ground wheel 120A relative to the front end 72 of the first side wing frame 70 and the second wing ground wheel actuator 122B can vary the height of the second wing ground wheel 120B relative to the front end 82 of the second wing frame 80. Working in conjunction, the ground wheel actuators 92, 92B, the first wing ground wheel actuator 122A, and the second wing ground wheel actuator 122B can raise or lower the front end 52 of the tilling section 50 relative to the ground surface.

The packer actuators 225 can pivot the packer assemblies 200 around the back end 54 of the tilling section 50. This varies the height of the packer rollers 210 connected behind the tilling section 50 relative to the back end 54 of the tilling section 50 and therefore the height of the back end 54 of the tilling section 50 relative to the ground surface.

The ground wheel actuators 92A, 92B, the first wing wheel actuator 122A, and the second wing wheel actuator 122B can be used to raise and lower the front end 52 of the tilling section 50 and the packer actuators 225 can be used to raise and lower the back end 54 of the tilling section 50. By using these actuators in conjunction, the height of the entire tilling section 50 relative to ground surface can be varied or the angle of the tilling section 50, front to back, can be varied.

Using all of the actuators together to lower the tilling section 50 closer to the ground surface, will increase the depth the soil engaging tools 150 penetrate the ground surface. Using all of the actuators together to raise the tilling section 50 further above the ground surface will decrease the depth the soil engaging tools 150 penetrate the ground surface.

By angling the tilling section 50, an operator can vary the depth of penetration of the first row of ground engaging tools 150A relative to the second row of ground engaging tools 150B. By angling the front end 52 of the tilling section 50 downwards and the back end 54 upwards, so that the front end 52 is lower than the back end 54, the first row of ground engaging tools 150A can penetrate the soil deeper than the second row of ground engaging tools 150B or even lift the second row of ground engaging tools 150B out of the soil completely. By angling the front end 52 of the tilling section 50 upwards and the back end 54 downwards, so that the front end 52 is higher than the back end 54, the second row of ground engaging tools 150B can penetrate the soil deeper than the first row of ground engaging tools 150A or even lift the first row of ground engaging tools 150A out of the soil completely.

For example, in drier conditions an operator may not want to fully cultivate or till the soil in order to conserve moisture, but some tillage may still be required to cut field residue. The operator may choose to tilt the tilling section 50 forwards so that the first row of ground engaging tools 150A engage with the soil, but the second row of ground engaging tools 150B do not. Alternatively, there may be a highly vegetative area of the field and the second row of engagement tools 150B may need to be engaged to penetrate the soil deeper. This can happen many times in a day where an operator finds they have to adjust the depth of the soil engaging tools 150 or the angle of the tilling section 50 at different parts in a field they are tilling with the cultivator 10.

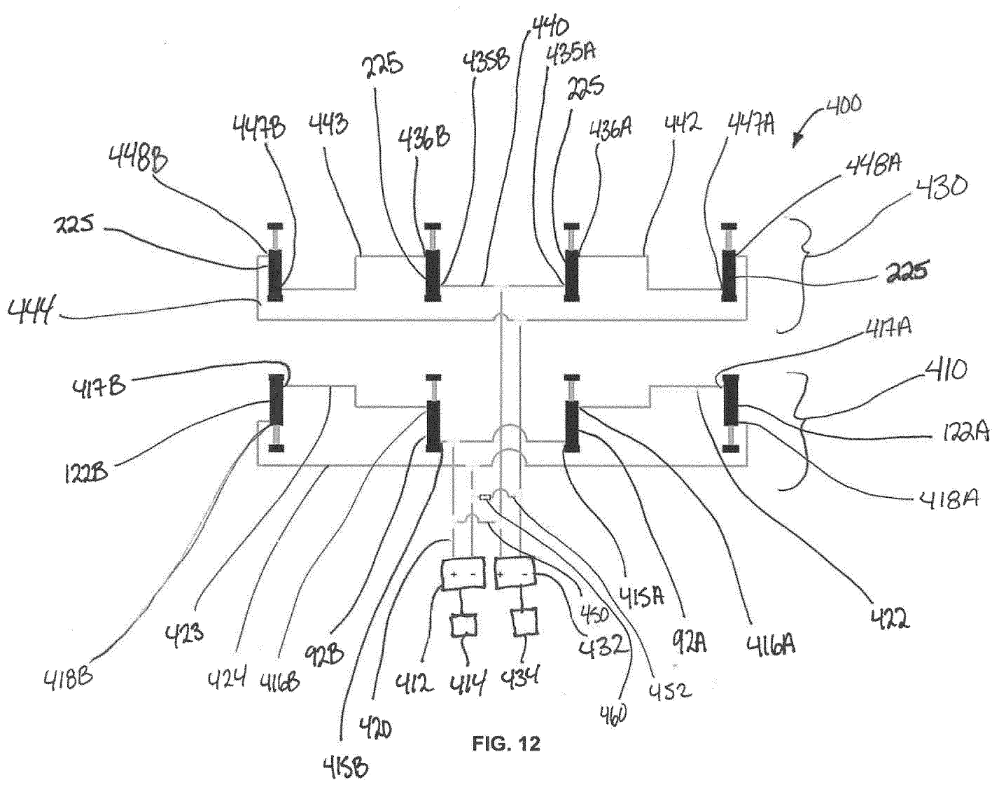

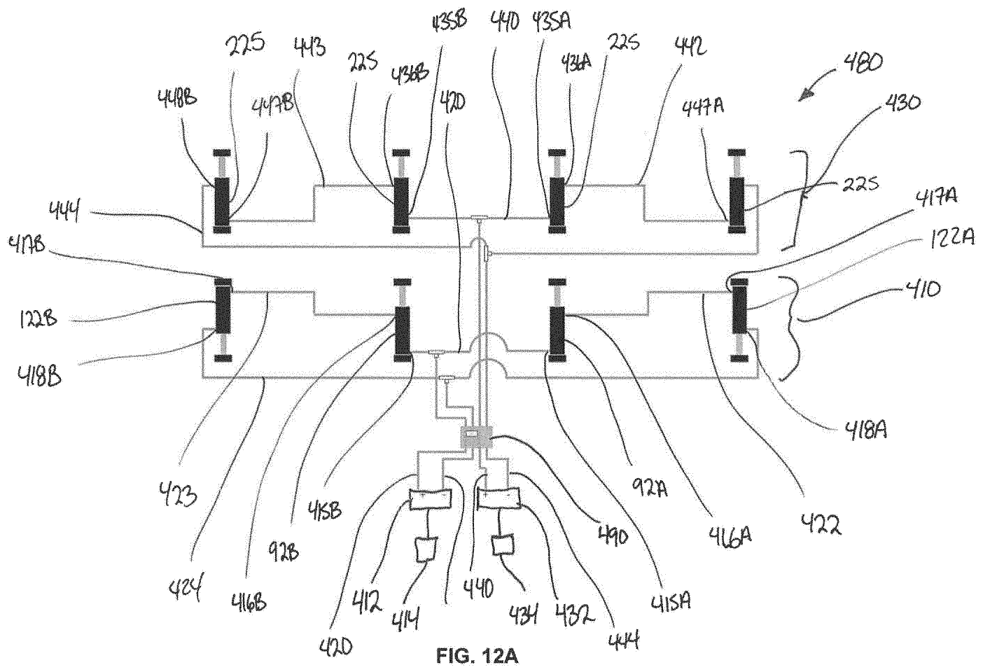

FIG. 12 illustrates a hydraulic circuit 400 for controlling the ground wheel actuators 92A, 92B, the first wing ground wheel actuator 122A, the second wing ground wheel actuator 122B and the packer actuators 225. The hydraulic circuit 400 can have: a front hydraulic circuit 410, connected to the ground wheel actuators 92A, 92B, the first wing ground wheel actuator 122A, and the second wing ground wheel actuator 122B for controlling these actuators; and a back hydraulic circuit 430, connected to the packer actuators 225 for controlling these actuators.

The front hydraulic circuit 410 can be controlled by a first control valve 412 that is operatively connected to a first input 414 in a cab of a tow vehicle (not shown) that an operator can engage to retract and extend the ground wheel actuators 92A, 92B, the first wing ground wheel actuator 122A, and the second wing ground wheel actuator 122B, thereby altering the height of the front end 52 of the tilling section 50.

The back hydraulic circuit 430 can be controlled by a second control valve 432 that is operatively connected to a second input 434 in a cab of the tow vehicle (not shown) that an operator can engage to retract and extend the packer actuators 225, thereby altering the height of the back end 54 of the tilling section 50.

The front hydraulic circuit 410 and the back hydraulic circuit 430 are fluidly connected allowing an operator to adjust the depth of the first row of ground engaging tools 150A and the second row of ground engaging tools 150 with either the first input 414 or the second input 434 in the cab of the tow vehicle without requiring the operator to engage the two different inputs 414, 434 separately. As the cultivator 10 is operating at high speed being towed through a field, multiple inputs to engage can require a lot of concentration by the operator, be stressful, and lead to greater amounts of operator fatigue.

A first front hydraulic flow line 420 can be connected from the first control valve 412 to first ports 415A, 415B of the ground wheel actuators 92A, 92B, to extend the ground wheel actuators 92A, 92B. Second front hydraulic flow lines 422, 423 can be connected from second ports 416A, 416B of the ground wheel actuators 92A, 92B to first ports 417A, 417B on the wing ground wheel actuators 122A, 122B, respectively, to route hydraulic fluid from the extending ground wheel actuators 92A, 92B to the wing ground wheel actuators 122A, 122B to extend the wing ground wheel actuators 122A, 122B. A third front hydraulic flow line 424 can be routed from second ports 418A, 418B on the wing ground wheel actuators 122A, 122B, respectively, back to the second control valve 432.

By using the first input 414 to route the hydraulic fluid the other way through the front hydraulic cylinder 410, hydraulic fluid can be routed from the first control valve 412 through the third front hydraulic flow line 424, rather than the first front hydraulic flow line 420, and to the second ports 418A, 418B of the wing ground wheel actuators 122A, 122B, the wing ground wheel actuators 122A, 122B can be retracted and the retraction of the wing ground wheel actuators 122A, 122B can force hydraulic fluid out of the first ports 417A, 417B of the wing ground wheel actuators 122A, 122B through the second front flow lines 422, 423 to the second ports 416A, 416B of the ground wheel actuators 92A, 92B, to retract the ground wheel actuators 92A, 92B.

A first back hydraulic flow line 440 can be connected from the second control valve 432 to first ports 435A, 435B of a first pair of packer actuators 225, to extend the first pair of packer actuators 225. Second back hydraulic flow lines 442, 443 can be connected from second ports 436A, 436B of the first pair of packer actuators 225 to first ports 447A, 447B on a second pair of packer actuators 225, to route hydraulic fluid forced out of the extending first pair of packer actuators 225 to the second pair of packer actuators 225 to extend the second pair of packer actuators 225. A third back hydraulic flow line 444 can be routed from second ports 448A, 448B on the second pair of packer actuators 225, back to the first control valve 412.

By using the second input 434 to route the hydraulic fluid the other way through the back hydraulic cylinder 430, hydraulic fluid can be routed from the second control valve 432 through the third back hydraulic flow line 444, rather than the first back hydraulic flow line 440, and to the second ports 448A, 448B on the second pair of packer actuators 225. This will cause the second pair of packer actuators 225 to be retracted and the retraction of the second pair of packer actuators 225 can force hydraulic fluid out of the first ports 447A, 447B on the second pair of packer actuators 225 through the second back flow lines 442, 443 to the second ports 436A, 436B of the first pair of packer actuators 225, 92B, to retract the first pair of packer actuators 225.

A first cross-over line 450 can be connected between the first front hydraulic flow line 420 and the first back hydraulic flow line 440 and a second cross-over line 452 can be connected between the third front hydraulic flow line 424 and the third back hydraulic flow line 444 to connect the front hydraulic circuit 410 and the back hydraulic circuit 430 in parallel. A restrictor 460 is shown connected inline in the second cross-over line 452, but it could also be connected inline with the first cross-over line 450.

When an operator engages the first input 414 to cause hydraulic fluid to flow through the first front hydraulic flow line 420 to the ground wheel actuators 92A, 92B, the first wing wheel actuator 122A, and the second wing wheel actuator 122B to extend these actuators, raising the front end 52 of the tilling section 50 and decreasing the depth the first row of ground engaging tools 150A engage the soil, some of this hydraulic fluid flowing through the first front hydraulic flow line 420 will try and pass through the first cross-over line 450 to the first back hydraulic flow line 440 to the packer actuators 225. However, the pressure of the hydraulic fluid in the first back hydraulic flow line 440, the second back hydraulic flow lines 442, 443 and the third back hydraulic flow line 444, caused by the restrictor 460 restricting the flow of hydraulic fluid through the second cross-over line 452 will restrict the amount of hydraulic fluid flowing that flows from the first hydraulic circuit 410 causing the packer actuators 225 to extend, but to extend slower than the ground wheel actuators 92A, 92B, the first wing wheel actuator 122A, and the second wing wheel actuator 122B.

The restrictor 460 inline with the second cross-over line 452 can have a smaller orifice through which hydraulic fluid can flow thereby reducing the flow of hydraulic fluid through this restrictor 460 or restricting it. In this manner, restrictor 460 will cause one of the connected hydraulic circuits to have a decreased flow of hydraulic fluid passing through it. If hydraulic fluid is routed through the first hydraulic circuit 410, some of this flow of hydraulic flow will flow to the connected second hydraulic circuit 430, but the restrictor 460 will cause the flow of hydraulic fluid through the second hydraulic circuit 430 to be less than the flow of hydraulic fluid through the first hydraulic circuit 410. Alternatively, if hydraulic fluid is routed through the second hydraulic circuit 430, some of this flow of hydraulic flow will flow to the connected first hydraulic circuit 410, but the restrictor 460 will cause the flow of hydraulic fluid through the first hydraulic circuit 410 to be less than the flow of hydraulic fluid through the second hydraulic circuit 430.

In this manner, the ground wheel actuators 92A, 92B the first wing ground wheel actuator 122A, and the second wing ground wheel actuator 122B will extend; raising the front end 52 of the tilling section 50. The restrictor valve 460, the first cross-over line 450, and the second cross-over line 452 can allow hydraulic fluid to flow from the first hydraulic circuit 410 to the second hydraulic circuit 430, but at a reduced amount of flow from the flow of hydraulic flow flowing through the first hydraulic circuit 410. This will in turn allow hydraulic fluid flowing through the first front hydraulic flow lines 420 to flow through the first cross-over line 450, since the hydraulic fluid in the back hydraulic circuit 430 has somewhere to flow, to the back hydraulic circuit 430 to extend the packer actuators 225 and raise the back end 54 of the tilling section 50, but at a slower rate than the extension of the ground wheel actuators 92A, the first wing ground wheel actuator 122A, and the second wing ground wheel actuator 122B because of the reduced flow of hydraulic fluid in the back hydraulic circuit 430.

The tilling section 50 can also be lowered by using the first input 414. The first input 414 can be used to route hydraulic fluid from the first control valve 412, through the third front hydraulic flow line 424, to retract the wing ground wheel actuators 122A, 122B and the ground wheel actuators 92A, 92B; lowering the front end 52 of the tilling section 50. The restrictor valve 460, the first cross-over line 450, and the second cross-over line 452 can allow hydraulic fluid to flow from the first hydraulic circuit 410 to the second hydraulic circuit 430, but at a reduced amount of flow from the flow of hydraulic flow flowing through the first hydraulic circuit 410. Hydraulic fluid flowing into the third back hydraulic flow line 444 from the first hydraulic circuit 410 through the second cross-over line 452, can flow to the packer actuators 225, retracting these packer actuators 225, but at a slower rate than the retraction of the ground wheel actuators 92A, the first wing ground wheel actuator 122A, and the second wing ground wheel actuator 122B. Hydraulic fluid that flows out of the first pair of packer actuators 225 can flow through the first cross-over line 450, to the first front hydraulic fluid flow line 420 and back to the first control valve 412. Retracting the packer actuators 225 will lower the back end 54 of the tilling section 50.

In this manner, the height of the front end 52 of the tilling section 50 can first be adjusted by using the first input 412 and first control valve 414 to extend or retract the ground wheel actuators 92A, 92B, the first wing ground wheel actuator 122A, and the second wing ground wheel actuator 122B in the first hydraulic circuit 410, and hydraulic fluid can be routed from the front hydraulic circuit 410 to the back hydraulic circuit 430 to cause the packer actuators 224 to perform the same action as the ground wheel actuators 92A, 92B, the first wing ground wheel actuator 122A, and the second wing ground wheel actuator 122B and adjust the height of the rear end 54 of the tilling section 50, but at a slower rate because of the restrictor 460. An operator can stop using the first input 414 at any time when a desired angle of the tilling section 50 is achieved.

The second input 434 can also be used instead of the first input 414 to adjust the height of the tilling section 50. However, when the second input 434 is used, the height of the back end 54 of the tilling section 50 is adjusted first, followed by the front end 52 of the tilling section 50, which is opposite from what occurs when the first input 414 is used. The second input 434 can be used by an operator to route hydraulic fluid from the second control valve 432 through the back hydraulic circuit 430 causing the packer actuators 225 to extend or retract to adjust the height of the back end 54 of the tilling section 50. The restrictor valve 460, the first cross-over line 450, and the second cross-over line 452 can allow hydraulic fluid to flow from the second hydraulic circuit 430 to the first hydraulic circuit 410, but at a reduced amount of flow from the flow of hydraulic flow flowing through the second hydraulic circuit 430. Hydraulic fluid flowing through the first cross-over line 450 and the second cross-over line 452, from the back hydraulic circuit 430 to the front hydraulic circuit 410 can cause the ground wheel actuators 92A, 92B, the first wing ground wheel actuator 122A, and the second wing ground wheel actuator 122B to perform the same action as the packer actuators 225, but at a slower rate, to adjust the height of the front end 52 of the tilling section 50. An operator can stop using the second input 434 at any time when a desired angle of the tilling section 50 is achieved.

Referring to FIG. 12A, in a further aspect, a hydraulic circuit 480 for controlling the ground wheel actuators 92A, 92B, the first wing ground wheel actuator 122A, the second wing ground wheel actuator 122B and the packer actuators 225 having a sequence valve 490 is shown. The hydraulic circuit 480, like the hydraulic circuit 400, can have: a front hydraulic circuit 410, connected to the ground wheel actuators 92A, 92B, the first wing ground wheel actuator 122A, and the second wing ground wheel actuator 122B for controlling these actuators; and a back hydraulic circuit 430, connected to the packer actuators 225 for controlling these actuators.

The first front hydraulic flow line 420 can be connected from the first control valve 412 to first ports 415A, 415B of the ground wheel actuators 92A, 92B, to extend the ground wheel actuators 92A, 92B. The second front hydraulic flow lines 422, 423 can be connected from second ports 416A, 416B of the ground wheel actuators 92A, 92B to first ports 417A, 417B on the wing ground wheel actuators 122A, 122B, respectively, to route hydraulic fluid from the extending ground wheel actuators 92A, 9B to the wing ground wheel actuators 122A, 122B to extend the wing ground wheel actuators 122A, 122B. The third front hydraulic flow line 424 can be routed from second ports 418A, 418B on the wing ground wheel actuators 122A, 122B, respectively, back to the first control valve 412.

The first back hydraulic flow line 440 can be connected from the second control valve 432 to first ports 435A, 435B of a first pair of packer actuators 225, to extend the first pair of packer actuators 225. The second back hydraulic flow lines 442, 443 can be connected from second ports 436A, 436B of the first pair of packer actuators 225 to first ports 447A, 447B on a second pair of packer actuators 225, to route hydraulic fluid forced out of the extending first pair of packer actuators 225 to the second pair of packer actuators 225 to extend the second pair of packer actuators 225. The third back hydraulic flow line 444 can be routed from second ports 418A, 418B on the second pair of packer actuators 225, back to the first control valve 412.

The sequence valve 490 is shown connected inline with the first front hydraulic flow line 420, the third front hydraulic flow line 424, the first back hydraulic flow line 440, and the third back hydraulic flow line 444. When a set pressure is reached, which will occur after a period of time has passed and the pressure has built up in a first of the hydraulic circuits, the sequence valve 490 will open and fluidly connect the front hydraulic circuit 410 and the back hydraulic circuit 430 together.

When an operator engages the first input 414 to cause hydraulic fluid to flow through the first front hydraulic flow line 420 to the ground wheel actuators 92A, 92B, the first wing wheel actuator 122A, and the second wing wheel actuator 122B to extend these actuators, raising the front end 52 of the tilling section 50 and decreasing the depth the first row of ground engaging tools 150A engage the soil. Initially, the sequence valve 490 will keep the front hydraulic circuit 410 and the back hydraulic circuit 430 isolated from one another (with the exception that there may be a small orifice in the sequence valve 490 to flow some hydraulic fluid between the front hydraulic circuit 410 and the back hydraulic circuit 430 before the sequence valve 490 opens). After a period of time has passed, the sequencing valve 490 can open and allow the flow of hydraulic fluid, flowing through the front hydraulic circuit 410, to flow to the back hydraulic circuit 430 and extend the packer actuators 225.

In this manner, the ground wheel actuators 92A, 92B, the first wing ground wheel actuator 122A, and the second wing ground wheel actuator 122B will first extend; raising the front end 52 of the tilling section 50. After a period of time, typically sufficient for the ground wheel actuators 92A, 92B, the first wing ground wheel actuator 122A, and the second wing ground wheel actuator 122B to fully extend, the sequencing valve 490 can fully open, routing pressurized hydraulic fluid from the front hydraulic circuit 410 to the back hydraulic circuit 430 to extend the packer actuators 225 and raise the back end 54 of the tilling section 50. If the ground wheel actuators 92A, 92B, the first wing ground wheel actuator 122A, and the second wing ground wheel actuator 122B are fully extended, most, if not all of the hydraulic flow, can flow through the back hydraulic circuit 430, until the packer actuators 225 are also fully extended.

The tilling section 50 can also be lowered by using the first input 414. The first input 414 can be used to route hydraulic fluid from the first control valve 412, through the third front hydraulic flow line 424, to retract the wing ground wheel actuators 122A, 122B and the ground wheel actuators 92A, 92B; lowering the front end 52 of the tilling section 50. Initially, the sequencing valve 490 will prevent a substantial amount of hydraulic fluid from flowing from the front hydraulic circuit 410 to the back hydraulic circuit 430. However, once a period of time has passed, the sequence valve 490 can open which will route hydraulic fluid from the from the front hydraulic circuit 410 to the back hydraulic circuit 430 and to the packer actuators 225; retracting these packer actuators 225. Retracting the packer actuators 225 will lower the back end 54 of the tilling section 50.

In this manner, the height of the front end 52 of the tilling section 50 can first be adjusted by using the first input 414 and first control valve 412 to extend or retract the ground wheel actuators 92A, 92B, the first wing ground wheel actuator 122A, and the second wing ground wheel actuator 122B, then, when the sequence valve 490 is opened, hydraulic fluid can be routed from the front hydraulic circuit 410 to the back hydraulic circuit 430 to cause the packer actuators 225 to perform the same action as the ground wheel actuators 92A, 92B, the first wing ground wheel actuator 122A, and the second wing ground wheel actuator 122B and adjust the height of the rear end 54 of the tilling section 50. An operator can stop using the first input 414 at any time when a desired angle of the tilling section 50 is achieved.

The second input 434 can also be used instead of the first input 414 to adjust the height of the tilling section 50. However, when the second input 434 is used, the height of the back end 54 of the tilling section 50 is adjusted first, followed by the front end 52 of the tilling section 50, which is opposite from what occurs when the first input 414 is used. The second input 434 can be used by an operator to route hydraulic fluid from the second control valve 432 through the back hydraulic circuit 430 causing the packer actuators 225 to extend or retract to adjust the height of the back end 54 of the tilling section 50. Initially, the sequence valve 490 will prevent a significant flow of hydraulic fluid between the back hydraulic circuit 430 and the front hydraulic circuit 410 (with the exception that there may be a small orifice to allow a slight flow of hydraulic fluid through the sequence valve 490 before the sequence valve 490 opens). After a period of time, the sequence valve 490 can open, allowing hydraulic fluid to flow from the back hydraulic circuit 430 to the front hydraulic circuit 410 to cause the ground wheel actuators 92A, 92B, the first wing ground wheel actuator 122A, and the second wing ground wheel actuator 122B to perform the same action as the packer actuators 225, and adjust the height of the front end 52 of the tilling section 50. An operator can stop using the second input 434 at any time when a desired angle of the tilling section 50 is achieved.

Referring again to FIGS. 1-3, the cultivator 10 requires precise contouring to engage the soil in a field and prepare a seed bed. To engage the soil, the cultivator 10 will typically be quite heavy, and especially the tilling section 50, with the weight being used to ensure the ground engaging tools 150 penetrate into the soil and remain engaged in the soil as the cultivator 10 is pulled through the field and encounters different amounts of vegetation and soil conditions. However, as the cultivator 10 is pulled through a field, it can encounter an immovable objects, such as a stone(s) or rough terrain. The tilling section 50, and specifically the rear frame 60, the first wing frame 70, or the second wing frame 80, supporting the packing assemblies 200 and having the packer rollers 210 that hit the immovable object or rough terrain can receive a substantial shock load to it's structure. Incorporating a suspension between the packing assemblies 200 and the tilling section 50 can reduce this shock load, reducing or preventing damage being inflicted and lengthen the life of the cultivator 10.

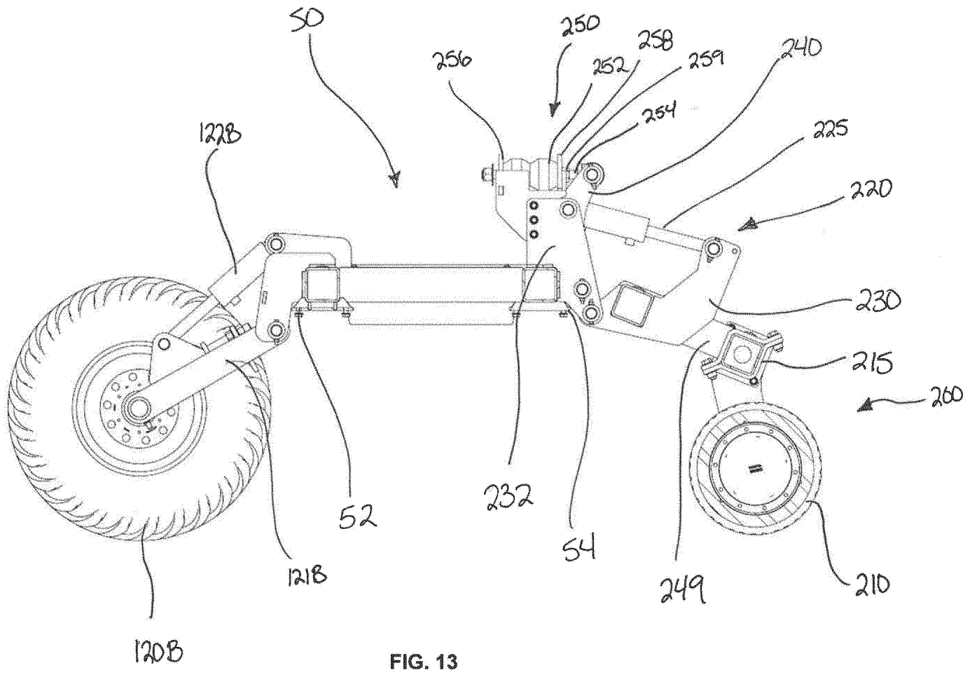

Referring again to FIGS. 4 and 5, suspension elements 250 can be incorporated between the tilling section 50 and the packing assemblies 200 to absorb a shock load caused by a packer roller 210 on a packing assembly 200 hitting an immovable object or rough terrain. Referring to FIG. 13, the suspension element 250 can include: a compression element 252, such as a rubber compression element, that dampens a compression load; a rod 254 that holds the compression element 252; a front plate 256 to secure a first side of the compression element 252, a back plate 258 to secure a second side of the compression element 252, and an adjustment nut 259 to position the front plate 256 against the first side of the compression element 252.

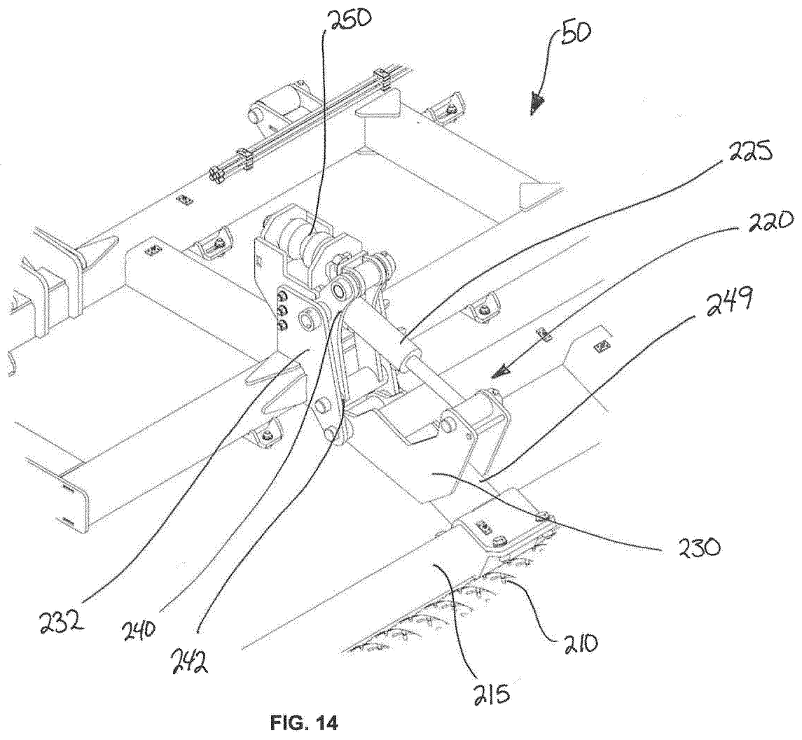

Referring to FIG. 14, the bracket assembly 220 can include: the packer actuator 225, the packer bracket 230; the frame bracket 232; an intermediate link 240; the roller linkage 249 and a suspension element 250. Rather than the packer actuator 225 being connected directly between the tilling section 50 and the bracket assembly 220, the suspension element 250 and the intermediate link 240 connect the packer actuator 225 to the tilling section 50 of the cultivator 10. The suspension element 250 is connected between the frame bracket 232 on the tilling section 50 and the intermediate link 240 and the packer actuator 225 is connected between intermediate link 240 and the packer bracket 230 on the bracket assembly 220.

The intermediate link 240 is pivotally connected to the frame bracket 232 at the first end 242 of the intermediate link 240 so that the intermediate link 240 can pivot around the first end 242 of the intermediate link 240 relative to the frame bracket 232.

A first end of the packer actuator 225 can be connected to the intermediate link 240, a first distance from the first end 242 of the intermediate link 240, and a second end of the packer actuator 225 can be connected to the packer bracket 230.

The suspension element 250 can be connected at a first end to the frame bracket 232 and at a second end to the intermediate link 240, a second distance from the first end 242 of the intermediate link 240. In one aspect, the first distance the first end of the packer actuator 225 is connected from the first end 242 of the intermediate link 240 can be less than the second distance the second end of the suspension element 250 is connected from the first end 242 of the intermediate link 240.

When the cultivator 10 is in the field position and being pulled through a field, the packer actuator 225 is pressurized to keep the packer roller 210 at a desired height relative to back end 54 of the tilling section 50. This means the packer actuator 225 is pressurized to keep it from retracting and can act as a solid member. When the packer roller 210 hits an unmovable object or rough terrain that jars the packer roller 210, the bracket assembly 220 will try to pivot upwards around the back end 54 of the tilling section 50 and the force of this shock will move through the packer bracket 230 and the packer actuator 225, which will be pressurized to keep it from retracting, to the intermediate link 240. This shock can pivot the intermediate link 240 around its first end 242, which is pivotally connected to the frame bracket 232. The suspension element 250 connected between the intermediate link 240 and the frame bracket 232 will be compressed by the intermediate link 24. The shock force transmitted through the packer actuator 225 will be transmitted by the intermediate link 240 to the suspension element 250 where some or all of this force can be absorbed by the compression element 252 of the suspension element 250, rather than being transmitted directly to the frame in the tilling section 50.

The intermediate link 240 allows the suspension element 250 to be aligned so that the forces the suspension element 250 and the compression element 252 is subjected to from the packer actuator 225 and the pivoting of the bracket assembly 200 are substantially linear. In this manner, the suspension element 250, and specifically the compression element 252, will be subjected to a substantially linear (or compression) load.

The compression element 252 is provided on the rod 254 and the rod 254 is connected between the frame bracket 232 and the intermediate link 240. The back plate 258 can be provided proximate or even as part of the frame bracket 232. The compression element 252 is positioned on the rod 254 adjacent to the back plate 258. The front plate 256 can be positioned against the other side of the compression element 252 and the adjustment nut 259 can be used to set the position of the front plate 256 against the compression element 252. The adjustment nut 259 can be used to tune the suspension element 250 and adjust the linear load by pre-compressing the compression element 252 to maintain a desired level of the packer assembly 200.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A cultivator comprising:
a main frame having a front end and a back end;
a hitch assembly connected to the front end of the main frame;
a tilling section pivotally attached to the back end of the main frame to pivot around a pivot axis;
a pair of main ground wheels attached to the main frame, the main ground wheels defining a ground wheel axis passing through centers of the main ground wheels;
a first wing ground wheel and a second wing ground wheel attached to a front end of the tilling section; and
a plurality of ground engaging tools connected to and extending below the tilling section,
wherein the ground wheel axis is substantially aligned with the pivot axis in a horizontal direction.

2. The cultivator of claim 1 wherein the ground wheel axis is positioned proximate the back end of the main frame.

3. The cultivator of claim 1 wherein the tilling section comprises: a rear frame; a first wing frame; and a second wing frame.

4. The cultivator of claim 3 wherein the tilling section is pivotally attached to the back end of the main frame, by the back end of the main frame being pivotally connected to a front end of the rear frame.

5. The cultivator of claim 4 wherein a first side of the rear frame is pivotally connected to the first wing frame and a second side of the rear frame is pivotally connected to the second wing frame.

6. A cultivator comprising:
a main frame having a front end and a back end;
a hitch assembly connected to the front end of the main frame;
a tilling section having a front end and a back end, the tilling section pivotally attached to the back end of the main frame to pivot around a pivot axis;
a pair of main ground wheels vertically moveable relative to the front end of the tilling section;
ground wheel actuators connected to the main ground wheels to vertically raise and lower the main grounds wheels relative to the front end of the tilling section;
a first wing ground wheel and a second ground wheel vertically moveable relative to the front end of the tilling section;
a first wing ground wheel actuator connected to the first wing ground wheel to move the first wing ground wheel vertically;
a second wing ground wheel actuator connected to the second wing ground wheel to move the second wing ground wheel vertically;
a plurality of ground engaging tools connected to and extending below the tilling section, the plurality of ground engaging tools comprising:
a first row of ground engaging tools; and,
a second row of ground engaging tools, the first row of ground engaging tools positioned in front of and parallel to the second row of ground engaging tools
a plurality of packer assemblies pivotally connected to the back end of the tilling section, each packer assembly having a packer roller, the packer roller vertically moveable relative to a back end of the tilling section;
a packer actuator connected between the tilling section and each packer assembly to raise and lower the packer roller;
a front hydraulic circuit operably connected to the main ground wheel actuators to extend and retract the main ground wheel actuators;
a back hydraulic circuit operably connected to the packer actuators to extend and retract the packer actuators; and
wherein the front hydraulic circuit and the back hydraulic circuit are operably connected in parallel.

7. The cultivator of claim 6 wherein the front hydraulic circuit is operatively connected to a first input and the back hydraulic circuit is operatively connected to a second input.

8. The cultivator of claim 6 wherein the front hydraulic circuit and the back hydraulic circuit are operably connected by a restrictor.

9. The cultivator of claim 6 wherein the front hydraulic circuit and the back hydraulic circuit are operably connected by a sequence valve.

10. The cultivator of claim 6 wherein the main ground wheels are vertically moveably attached to the main frame by swing arms, and wherein the ground wheel actuators are connected to the swing arms, and wherein the main ground wheels move vertically through an arc defined by the swing arms.

11. The cultivator of claim 10 wherein the a first wing ground wheel and the second wing ground wheel are moveably attached to the tilling section by swing arms, and wherein the first wing ground wheel actuator and the second wing ground wheel actuator are connected to the swing arms, and wherein first wing ground wheel and the second wing ground wheel move vertically through an arc defined by the swing arms.

12. The cultivator of claim 7 wherein the front hydraulic circuit comprises: a first control valve operatively to the first input; a first front flow line connected between the first control valve and first ports on the ground wheel actuators; second front hydraulic flow lines connected between second ports on the ground wheel actuators and first ports on the first ground wheel actuator and the second ground wheel actuator; and a third front hydraulic flow line connected between second ports on the wing ground wheel actuators and the first control valve.

13. The cultivator of claim 11 wherein the back hydraulic circuit comprises: a second control valve operatively connected to the second input; a first back hydraulic flow line connected between the second control valve and first ports on a first pair of packer actuators; second back hydraulic flow lines connected between second ports of the first pair of packer actuators to first ports on a second pair of packer actuators; and a third back hydraulic flow line connected from second ports on the second pair of packer actuators to the second control valve.

14. A cultivator comprising:
a hitch assembly connectable to a tow vehicle;
a tilling section having a front end and a back end;
a plurality of ground engaging tools connected to and extending below the tilling section;
a packer assembly pivotally connected to the back end of the tilling section and having a packer roller, the packer roller vertically moveable relative to a back end of the tilling section;
a packer actuator connected to the packer assembly to raise and lower the packer roller; and
a suspension element operably connected between the packer actuator and the tilling section, the element having a compression element to absorb a compression load.

15. The cultivator of claim 14 further comprising:
a frame bracket connected to the tilling section and extending upwards, a first end of the suspension element connected to the frame bracket;
an intermediate link pivotally connected to the frame bracket, a second end of the suspension element connected to the intermediate link; and
a bracket assembly pivotally connecting the packer assembly to the back end of the tilling section, the bracket assembly having a packer bracket extending upwards,
wherein the packer actuator is connected at a first end to the intermediate link and a second end of the packer actuator is connected to the packer bracket.

16. The cultivator of claim 15 wherein the first end of the packer actuator is connected a first distance from the first end of the intermediate link, and wherein the second end of the suspension element is connected a second distance from the first end of the intermediate link.

17. The cultivator of claim 16 where in the first distance is less than the second distance.

18. The cultivator of claim 17 wherein the suspension element is oriented substantially horizontal.
